(19) United States
(12) Patent Application Publication
(10) Pub. No.: US 2007/0171127 A1
(43) Pub. Date: Jul. 26, 2007

(54) Triplate-type planar array antenna

(76) Inventors: Hisayoshi Mizugaki, Chikusei-shi (JP); Masahiko Oota, Oyama-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/587,906

(22) PCT Filed: Feb. 28, 2005
(86) PCT No.: PCT/JP05/03265

§ 371 Date: Jul. 31, 2006

(30) Foreign Application Priority Data
Mar. 2, 2004 (JP) 2004-057872

(51) Int. Cl. H01Q 1/38

(52) U.S. Cl. 343/700 MS

(57) ABSTRACT

A triplate-type planar array antenna is provided with an antenna circuit board (3) on which an antenna circuit including a plurality of radiating elements (5), which are vertically and horizontally arrayed in a two-dimensional manner, and feedlines (6) is formed; two pieces of dielectric substances (2a, 2b) between which the antenna circuit board (3) is sandwiched at the both sides; a ground conductor (1) laminated on one dielectric substance (2b); and a slot board (4) laminated on the other dielectric substance (2a). One or more slot openings (7) corresponding to the plurality of radiating elements (5) with a linear arrangement are formed on the slot board (4).

### TECHNICAL FIELD

The present invention relates to a triplate-type planar array antenna used for transmitting and receiving with a millimeter-wave band, and especially, to a triplate-type planar array antenna which can improve beam widths and a level of wide-angle side lobe.

### BACKGROUND ART

High gain and low side lobe characteristics are important for the planar array antenna used for an on-vehicle radar and a high-speed communication through a millimeter-wave band. There have been already well-known a planar array antenna that is a high gain planar array antenna which can be applied to the above uses, and by which reduction of a feedline loss and control of an unnecessary radiation of feedline can be realized (refer to, for example, Japanese Patent Application Laid-Open No. 4-82405).

Hereinafter, the outline of such a planar array antenna will be given, based on FIGS. 1 through 6.

FIG. 1 is an exploded perspective view showing an outline configuration of such a planar array antenna, especially, a triplate-type planar array antenna.

Referring to the drawing, a triplate-type planar array antenna according to a prior art is formed in such a way that an antenna circuit board 30 is sandwiched between a dielectric substance 20a underneath a slot board 40 and a dielectric substance 20b on a ground conductor 10. Here, the antenna circuit board 30 has a plurality of radiating elements 50, and feedlines 60 connecting the radiating elements that are formed of a flexible substrate that has a film base on which copper foil is laminated, and removing unnecessary copper foil by etching. Moreover, the slot board 40 has a plurality of slots 70 at positions corresponding to a plurality of radiating elements 50.

Here, the ground conductor 10 and the slot board 40 can use any kinds of metal boards, or plated plastic boards as material, and especially, aluminum boards are preferable for lightweight and low cost manufacturing. Moreover, the conductor 10 and the board 40 can be formed by etching removal of unnecessary copper foil on a flexible substrate having a film base on which copper foil is laminated. Furthermore, the conductor 10 and the board 40 can be formed even by using a copper clad laminate made of a thin resin board, wherein the thin resin board is made of woven glass fabrics impregnated with a resin and copper foil is laminated on the thin resin board.

Moreover, though the antenna circuit board 30 can be formed as described above, it can be formed even by using a copper clad laminate made of a thin resin board made of woven glass fabrics impregnated with a resin and copper foil is laminated on the thin resin board. Moreover, a foam material with a small relative dielectric constant to air is preferably used for the dielectric substances 20a and 20b.

FIG. 2 is an explanatory view of transverse propagation components in the case of the triplate-type planar array antenna according to the prior art. FIG. 3 is a diagram showing a relation among an element array spacing, a gain and an efficiency in the case of the triplate-type planar array antenna according to the prior art. FIG. 4 is a diagram showing a feeding power distribution for each element in the case of the triplate-type planar array antenna according to the prior art. FIG. 5 is a diagram showing the directivity of the triplate-type planar array antenna according to the prior art.

In the triplate-type planar array antenna, which has the above-described configuration, according to the prior art, components which are propagated in the transverse direction between the ground conductor 10 and the slot board 40 are generated other than energy components directly radiated from the slots 70 to the outside space as shown in FIG. 2 when the patch elements are driven from the feedlines 60. The above-described components are called components according to a transverse propagation mode (parallel plate mode). As the above-described propagation components are radiated from the adjoining slots 70 to the space, it has been known that the gain of the array antenna is influenced by a relation between the phase of the propagation component and that of the energy component directly radiated from the slot 70 to the outside space. That is, the gain of the array antenna shows a maximum point of the gain and the efficiency with a special spacing of element array as shown in FIG. 3, and thus a high gain and a high-efficiency antenna can be realized. Moreover, it has been well-known that the side lobe can be reduced as shown in FIG. 5 with a desired tapered distribution of supply power to each of the radiating elements 50 arrayed as shown in FIG. 4 compared with the side lobe under a uniform distribution in which the power is uniformly supplied.

As described above, the side lobe within an angle range of ±60 degrees can be reduced as shown in FIG. 5 with the desired tapered distribution of supply power to each of the arrayed radiating elements 50 in the triplate-type planar array antenna shown in FIG. 1.

However, as the array spacing is restricted in the neighborhood of 0.9 λo (λo is a free space wavelength) in order to achieve a high-efficiency antenna, it has been difficult as shown in FIG. 5 in an array antenna with four through eight array elements that the side lobe level of the direction of the wide angle of 60 degrees or larger is made about −20 dB or smaller. Moreover, as the element array spacing is restricted in the neighborhood of 0.9 λo (λo is a free space wavelength), and accordingly the beam width is reduced to about 15 degrees in an array antenna with, for example, about four array elements, it has been difficult in the array antenna with about four array elements to realize a beam width larger than about 15 degrees.

That is, in the triplate-type planar array antenna according to the prior art when the element array spacing is made smaller than 0.9 λo without considering the effects of the transverse propagation components, for example, when the element array spacing is reduced to 0.7 λo, an antenna with a wider beam width than that of an antenna having elements arrayed with a distance of 0.9 λo can be obtained as shown by the solid line of FIG. 6, considering the directivity of only the components radiated directly from the slots, and it is also expected to be possible to reduce the side lobe in the direction with wide angles of 60 degrees or more, depending on a distribution by which the elements are driven. However, there has been caused a problem that disorders are generated in the directivity, and the gain in the frontal direction is also reduced as shown by a dotted line in FIG. 6 to cause reduction in the efficiency because the phases of the transverse propagation components radiated from the adjacent slots are actually different from those of the components directly radiated from the related slots due to the effect of the transverse propagation components when the element array spacing is made smaller. Accordingly, it has been difficult to meet the requirements for reduction in the side lobe in the direction with wider angles and for wider beam widths.

### DISCLOSURE OF INVENTION

Accordingly, the object of the present invention is to provide a triplate-type planar array antenna in which there is a high degree of flexibility in setting beam widths on a desired radiating plane, and a lower side lobe level can be secured even in a wider-angle direction without deteriorating the characteristics of a high-gain and high-efficiency triplate-type planar array antenna according to the prior art.

In order to achieve the above-described object, according to a first aspect of the present invention, there is provided a triplate-type planar array antenna comprising: an antenna circuit board on which an antenna circuit including a plurality of radiating elements, which are vertically and horizontally arrayed in a two-dimensional manner, and feedlines is formed; two pieces of dielectric substances between which the antenna circuit board is sandwiched at the both sides; a ground conductor laminated on one dielectric substance; and a slot board laminated on the other dielectric substance, wherein the slot board has a plurality of slot openings, each corresponding to the plurality of radiating elements with a linear arrangement.

According to a second aspect of the present invention, the plurality of slot openings are formed on the slot board in series in the longitudinal direction of the slot openings in the first aspect of the present invention.

According to a third aspect of the present invention, a plurality of antenna circuits are formed on the antenna circuit board, the plurality of slot openings are formed on the slot board in series in the longitudinal direction of the slot openings, and the number of the plurality of slot openings corresponds to the number of the plurality of antenna circuits in the first aspect of the present invention.

According to a fourth aspect of the present invention, a plurality of antenna circuits are formed on the antenna circuit board, and at least one slot opening extending over at least two of the plurality of antenna circuits is formed on the slot board in series in the longitudinal direction of the slot openings in the first aspect of the present invention.

According to a fifth aspect of the present invention, each array spacing for the plurality of slot openings in a direction perpendicular to the longitudinal direction of the plurality of slot openings is set at 0.85 through 0.93 times a free space wavelength corresponding to a center frequency of a frequency band in use in any one of the first to fourth aspects of the present invention.

According to a sixth aspect of the present invention, each array spacing for the plurality of radiating elements in the longitudinal direction of the plurality of slot openings is set at 0.85 through 0.93 times a free space wavelength corresponding to a center frequency of a frequency band in use in any one of the first to fifth aspects of the present invention.

### BRIEF DESCRIPTION OF THE DRAWINGS

[FIG. 1] FIG. 1 is an exploded perspective view showing an outline configuration of a triplate-type planar array antenna according to a prior art.

[FIG. 2] FIG. 2 is an explanatory view of transverse propagation components in the case of the triplate-type planar array antenna according to the prior art.

[FIG. 3] FIG. 3 is a diagram showing a relation among an element array spacing, a gain, and an efficiency in the case of the triplate-type planar array antenna according to the prior art.

[FIG. 4] FIG. 4 is a diagram showing a feeding power distribution for each element in the case of the triplate-type planar array antenna according to the prior art.

FIG. 5 is a diagram showing the directivity of the triplate-type planar array antenna according to the prior art.

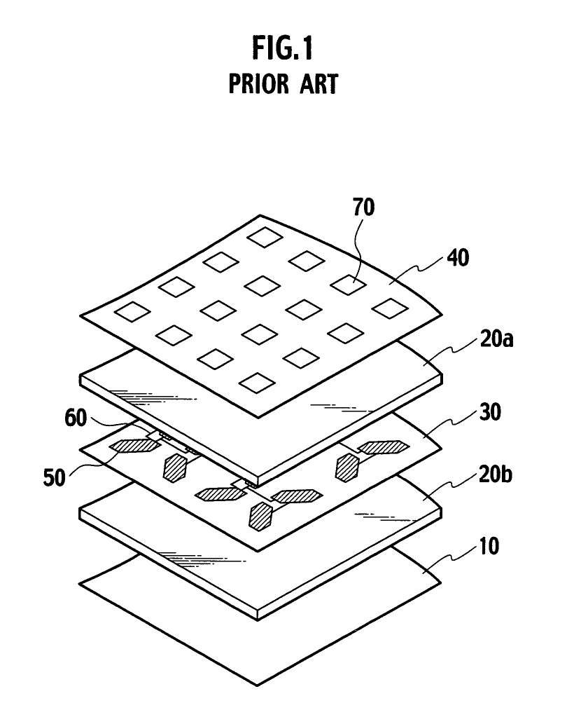

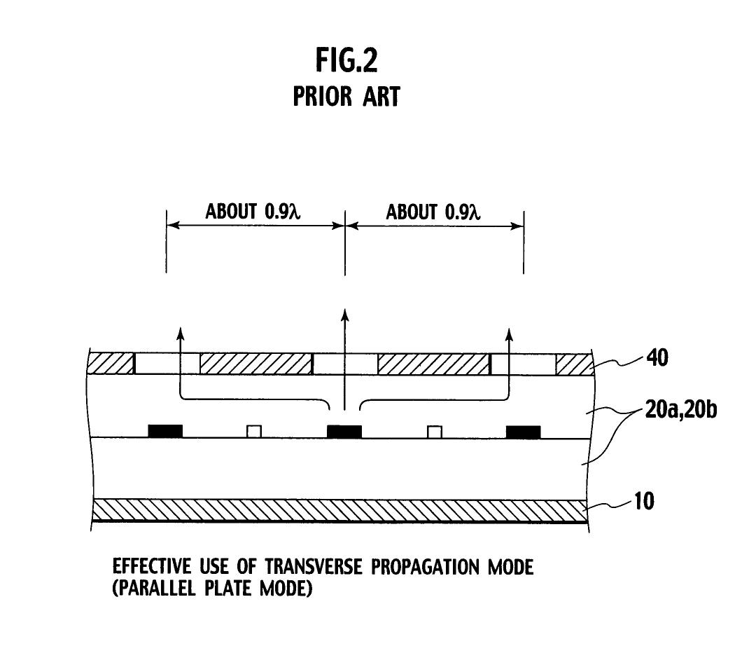

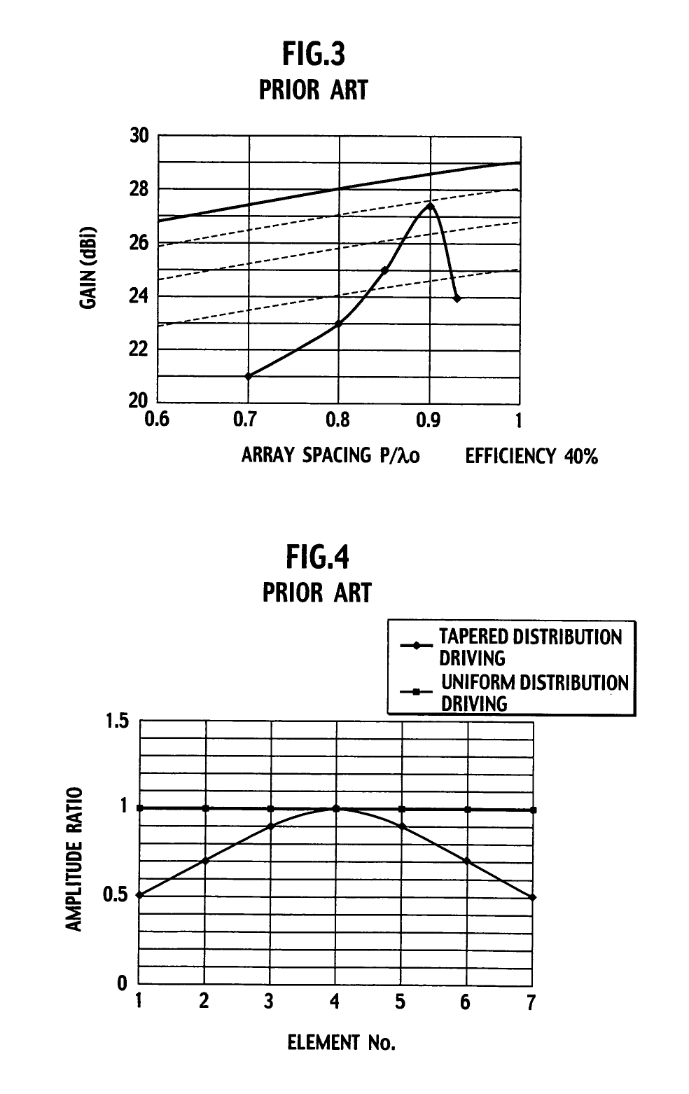

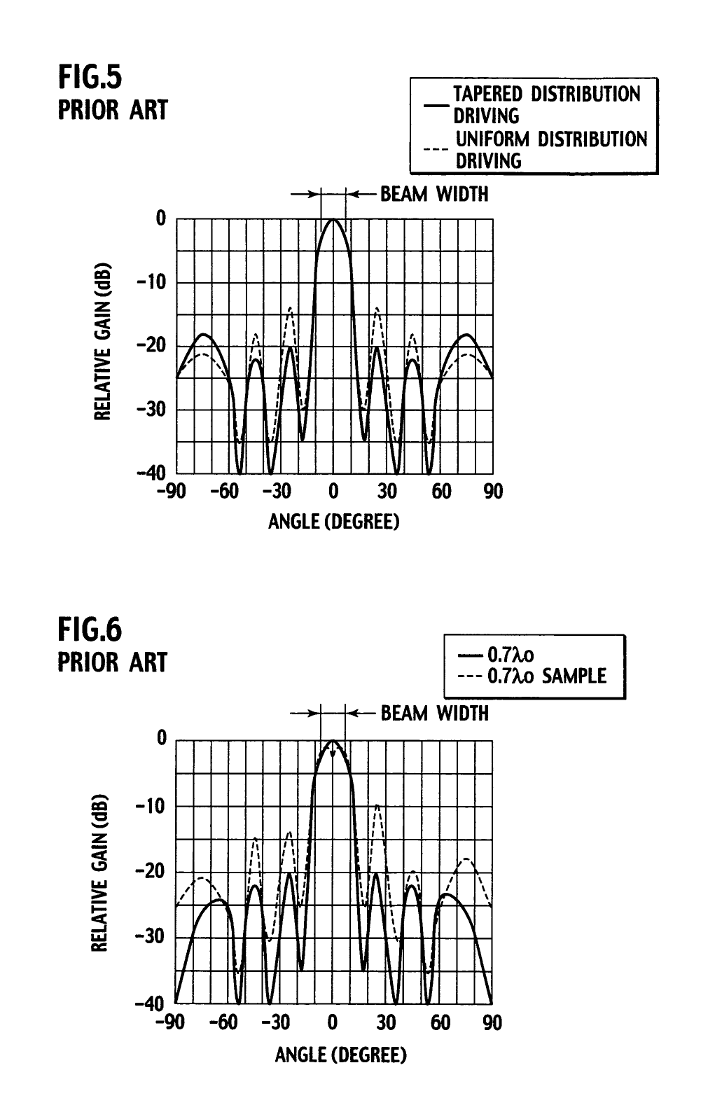

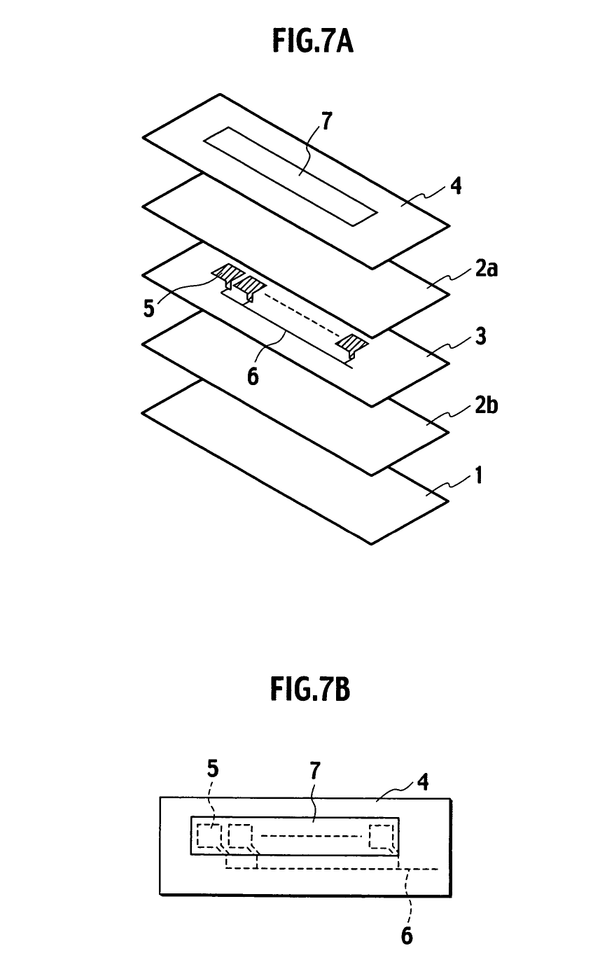

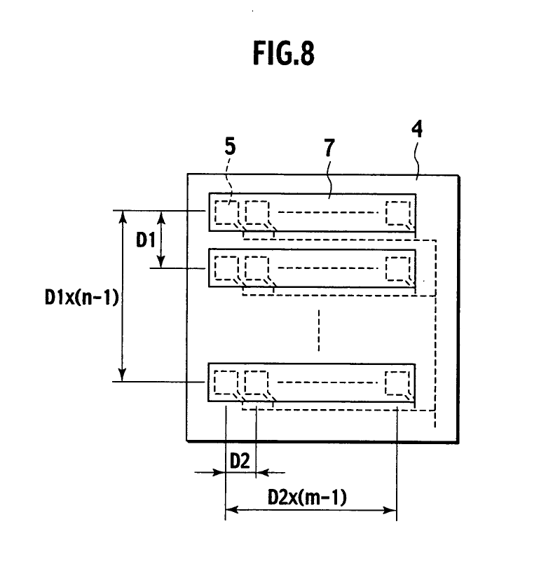

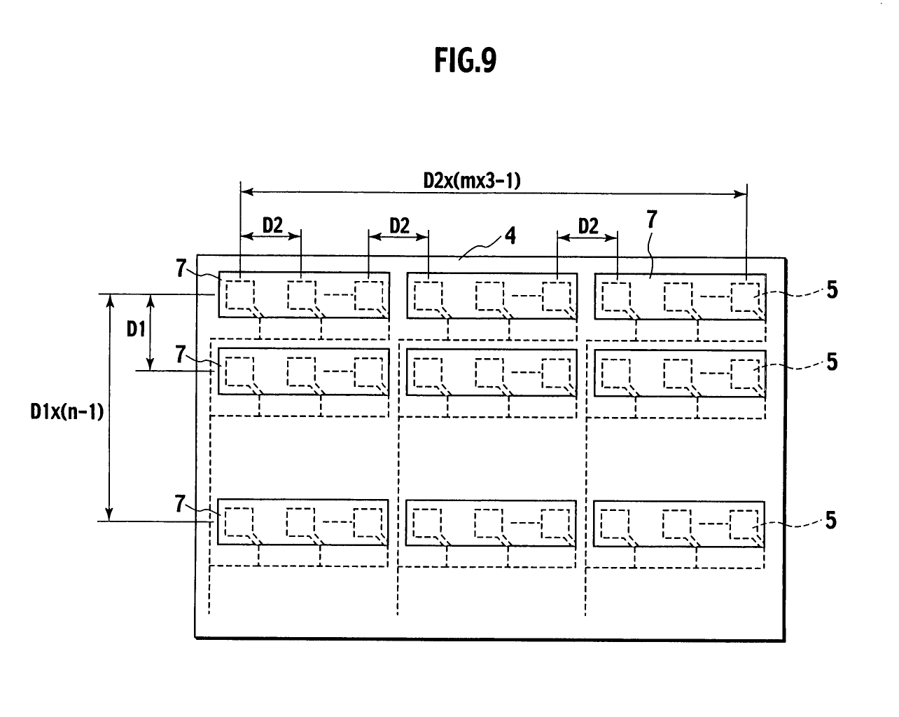

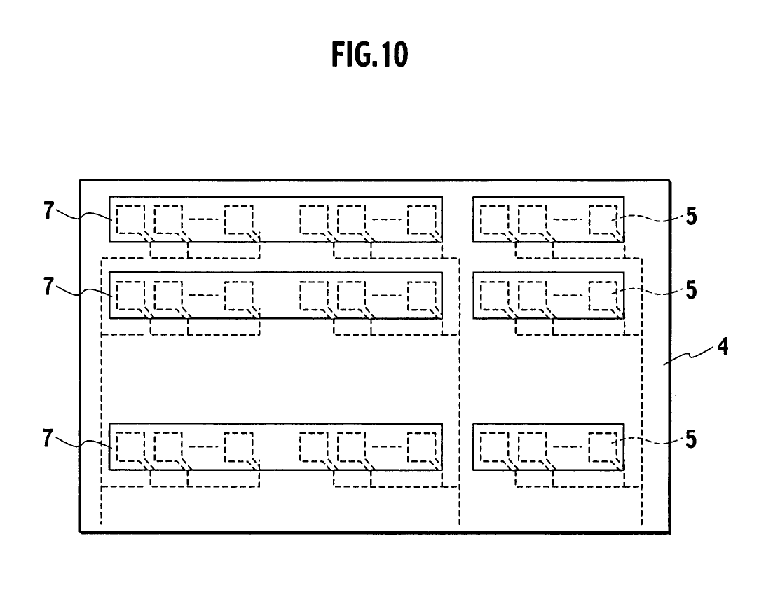

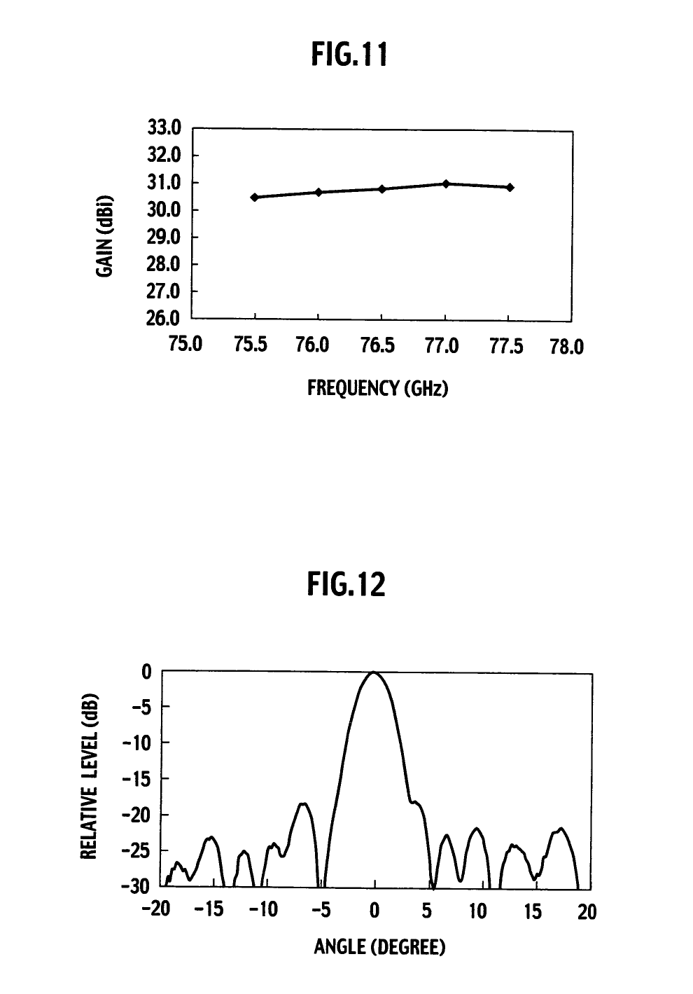

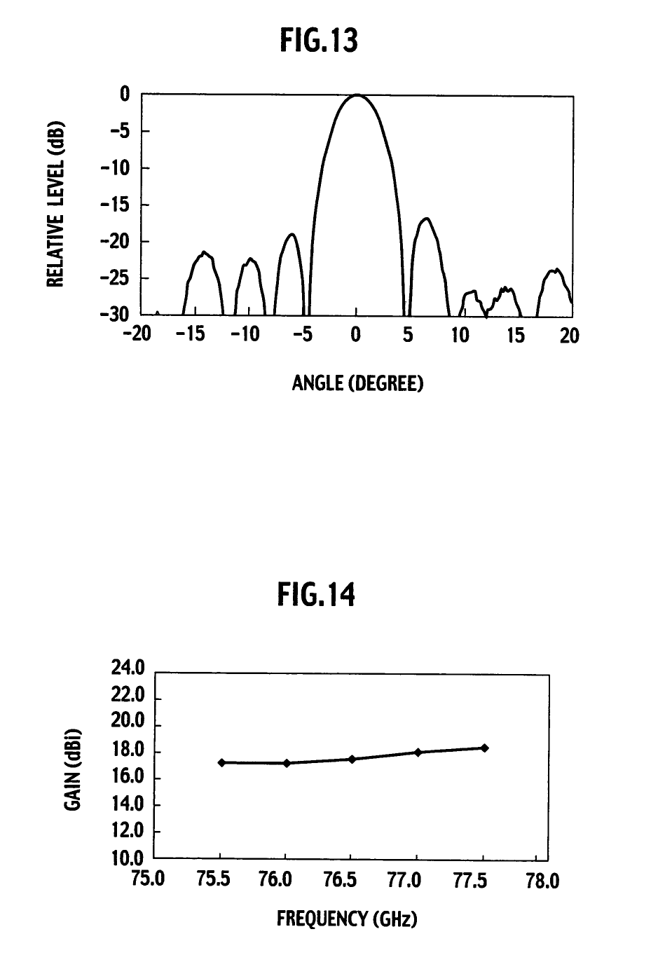

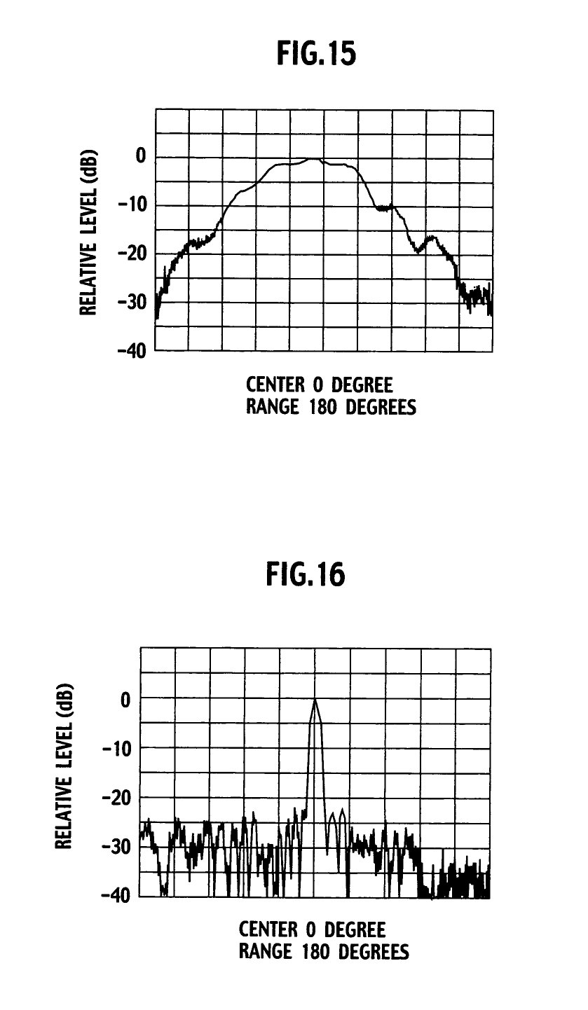

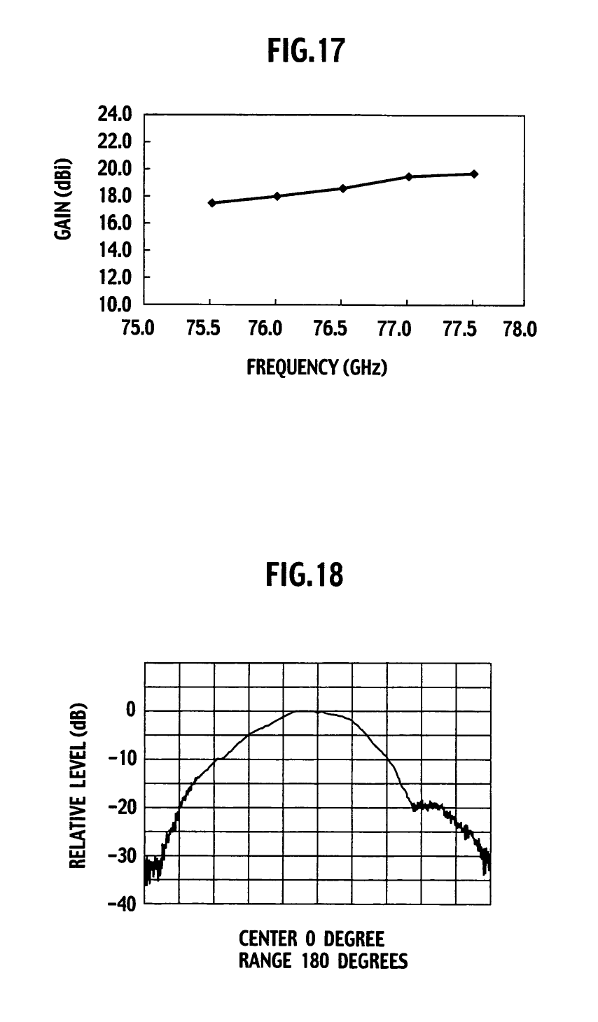

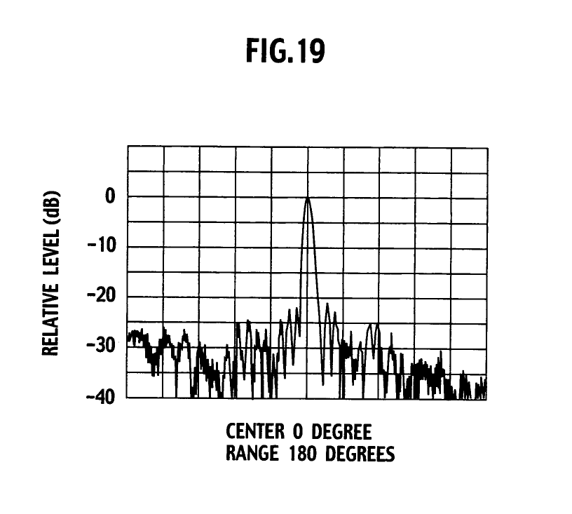

[FIG. 6] FIG. 6 is a diagram explaining the effects of the directivity of the triplate-type planar array antenna according to the prior art.

[FIG. 7] FIGS. 7A and 7B are views explaining a triplate-type planar array antenna according to one embodiment of the invention, in which FIG. 7A is an exploded perspective view showing the outline configuration of the antenna, and 7B is a top view thereof.

[FIG. 8] FIG. 8 is a block diagram showing a relation between a plurality of radiating elements and a plurality of slot openings in a triplate-type planar array antenna according to a first embodiment of the invention.

[FIG. 9] FIG. 9 is a block diagram showing a relation between a plurality of radiating elements and a plurality of slot openings in a triplate-type planar array antenna according to a second embodiment of the invention.

[FIG. 10] FIG. 10 is a block diagram showing a relation between a plurality of radiating elements and a plurality of slot openings in a triplate-type planar array antenna according to a third embodiment of the invention.

[FIG. 11] FIG. 11 is a view showing the gain of each of 384 radiating elements in the triplate-type planar array antenna according to the first embodiment.

[FIG. 12] FIG. 12 is a view showing the directivity (side lobe level) of a plane (horizontal plane) formed by 24 radiating elements, which are arranged in the horizontal direction, in the triplate-type planar array antenna according to the first embodiment.

[FIG. 13] FIG. 13 is a view showing the directivity (side lobe level) of a plane (vertical plane) formed by 16 radiating elements, which are arranged in the vertical direction, in the triplate-type planar array antenna according to the first embodiment.

[FIG. 14] FIG. 14 is a view showing the gain of each of 32 radiating elements in the triplate-type planar array antenna according to the second embodiment.

[FIG. 15] FIG. 15 is a view showing the directivity (side lobe level) of a plane (horizontal plane) formed by the two radiating elements, which are arranged in the horizontal direction, in the triplate-type planar array antenna according to the second embodiment.

[FIG. 16] FIG. 16 is a view showing the directivity (side lobe level) of a plane (vertical plane) formed by 16 radiating elements, which are arranged in the vertical direction, in the triplate-type planar array antenna according to the second embodiment.

[FIG. 17] FIG. 17 is a view showing the gain of each of 32 radiating elements in the triplate-type planar array antenna according to the third embodiment.

FIG. 18 is a view showing the directivity (side lobe level) of a plane (horizontal plane) formed by the two radiating elements, which are arranged in the horizontal direction, in the triplate-type planar array antenna according to the third embodiment.

[FIG. 19] FIG. 19 is a view showing the directivity (side lobe level) of a plane (vertical plane) formed by 16 radiating elements, which are arranged in the vertical direction, in the triplate-type planar array antenna according to the third embodiment.

Best Mode for Carrying out the Invention

Hereinafter, triplate-type planar array antennas according to embodiments of the present invention will be explained in detail, referring to drawings.

FIGS. 7A and 7B are a view explaining a triplate-type planar array antenna according to one embodiment of the invention; FIG. 7A is an exploded perspective view showing the outline configuration of the antenna; and FIG. 7B is a top view of the configuration.

The configuration of the triplate-type planar array antenna according to the invention shown in FIG. 7A is basically the same as that of the prior art. That is, the triplate-type planar array antenna according to one embodiment of the invention has a configuration in which an antenna circuit board 3 is sandwiched between a dielectric substance 2a underneath a slot board 4 and a dielectric substance 2b on a ground conductor 1. Here, the antenna circuit board 3 has a film base on which a plurality of radiating elements 5, and feedlines 6 connecting the radiating elements are formed by etching removal of unnecessary copper foil on a flexible substrate on which copper foil is laminated.

The difference from the configuration of the prior art is that a slot opening 7, which has a rectangular shape and corresponding to the plurality of radiating elements 5 with a linear arrangement, is formed on the slot board 4 as shown in FIGS. 7A and 7B.

Typically, the following embodiments, which includes one slot opening 7 shown in FIGS. 7A and 7B as a basic component, are considered as the realistic configuration of the triplate-type planar array antenna according to the invention.

### FIRST EMBODIMENT

FIG. 8 is a view explaining a triplate-type planar array antenna according to a first embodiment of the invention. Hereinafter, the longitudinal direction of the slot opening 7 is called a horizontal direction, and a direction perpendicular to the horizontal direction is called a vertical direction for simplification of the explanation.

The first embodiment has a configuration in which one slot opening 7 is corresponding to m total number of the radiating elements 5 in the horizontal direction, and n number of such slot openings 7 are vertically arranged in parallel to one another as shown in FIG. 8 when the radiating elements 5 are arrayed in (vertically n and horizontally m) on the antenna circuit board 3 in a typical two-dimensional manner.

In this case, it is preferable that each array (center) spacings D1 for the plurality of slot openings 7, that is, the array spacings D1 in the vertical direction is configured at 0.85 through 0.93 times the free space wavelength λo for the center frequency of a frequency band in use. Moreover, it is preferable that the array spacings D2 for the plurality of radiating elements 5 in the horizontal direction are also configured at 0.85 through 0.93 times the free space wavelength λo for the center frequency of the frequency band in use.

Here, experiments have been conducted under the following concrete conditions.

That is, an aluminum board with a thickness of 1 mm was used as the ground conductor 1, and polyethylene foam with a relative dielectric constant of about 1 and with a thickness of 0.3 mm was used as the dielectric substances 2a and 2b. Moreover, a film base with a configuration in which copper foil with a thickness 18 μm was laminated on a polyimide film with a thickness of 25 μm was used as the antenna circuit board 3, and the radiating elements 5 and the feedlines 6 were formed by etching removal of unnecessary copper foil on a flexible substrate. Moreover, the slot opening 7 was formed on an aluminum board with a thickness of 1 mm as the slot board 4 by punching according to presswork.

Moreover, the radiating elements 5 having a square shape with a side length of about 0.4 times the free space wavelength λo corresponding to a frequency of 76.5 GHz in use were formed on the antenna circuit board 3. Furthermore, the slot openings 7 having a rectangular shape with a short side length of about 0.55 times the free space wavelength λo were formed on the slot board 4.

In addition, the array spacings for the slot openings 7 in the vertical direction were set at about 0.9 times the free space wavelength λo in the above-described configuration. Moreover, the array spacings for the plurality of radiating elements 5 in the horizontal direction were arranged at about 0.9 times the free space wavelength λo. The radiating elements 5 were arranged at the above-described spacings, that is, 24 elements in the horizontal direction, and 16 elements in the vertical direction to form 384 elements in total. In other words, 24 radiating elements 5 were corresponding to one slot opening 7, that is, 16 slot openings 7 were configured to be provided in this case.

Experiment data was obtained under the above-described conditions as shown in FIGS. 11 through 13.

FIG. 11 is a view showing the gain of each of 384 radiating elements in the triplate-type planar array antenna with the above-described concrete configuration. FIG. 12 is a view showing the directivity (side lobe level) of a plane (horizontal plane) formed by 24 radiating elements, which are arranged in the horizontal direction, in the triplate-type planar array antenna with the above-described concrete configuration. FIG. 13 is a view showing the directivity (side lobe level) of a plane (vertical plane) formed by 16 radiating elements, which are arranged in the vertical direction, in the triplate-type planar array antenna with the above-described concrete configuration.

As shown in FIG. 11, each radiating element had a gain of 30.5 dBi or more, and the stable directivity (side lobe level) was obtained in the horizontal direction as shown in FIG. 12, and in the vertical direction as shown in FIG. 13.

### SECOND EMBODIMENT

FIG. 9 is a view explaining a configuration of triplate-type planar array antenna according to a second embodiment of the invention.

The second embodiment has a configuration in which a plurality of array antennas according to the first embodiment are provided on an antenna circuit board 3. Accordingly, the difference from the configuration of the first embodiment is that a plurality of slot openings 7 are provided on the antenna circuit board 3 in the horizontal direction.

It is also preferable in the second embodiment, as in the case of the first embodiment, that each array (center) spacing D1 for the plurality of slot openings 7, that is, the array spacings D1 in the vertical direction is configured at 0.85 through 0.93 times the free space wavelength λo for the center frequency of a frequency band in use. Moreover, it is preferable in the second embodiment, as in the case of the first embodiment, that the array spacings D2 for the plurality of radiating elements 5 in the horizontal direction are also configured at 0.85 through 0.93 times the free space wavelength λo for the center frequency of the frequency band in use.

Here, experiments have been conducted under the following concrete conditions.

That is, three array antennas were configured to be arranged in the horizontal direction. In other words, three slot openings 7 were provided in the horizontal direction. Moreover, 16 slot openings 7 were provided in the vertical direction. Two radiating elements 5 were configured to be corresponding to one slot opening 7. That is, the number of the radiating elements 5 in one array antenna was 2×16, namely, 32. Accordingly, the number of the radiating elements 5 was 32×3, namely, 96 for the whole planes. Conditions other than the above described ones are the same as those of the first embodiment.

Experiment data was obtained under the above-described conditions as shown in FIGS. 14 through 16.

FIG. 14 is a view showing the gain of each of 32 radiating elements in the triplate-type planar array antenna with the above-described concrete configuration. FIG. 15 is a view showing the directivity (side lobe level) of a plane (horizontal plane) formed by the two radiating elements, which are arranged in the horizontal direction, in the triplate-type planar array antenna with the above-described concrete configuration. FIG. 16 is a view showing the directivity (side lobe level) of a plane (vertical plane) formed by 16 radiating elements, which are arranged in the vertical direction, in the triplate-type planar array antenna with the above-described concrete configuration.

As shown in FIG. 14, each radiating element had a gain of 18 dBi or more, and the stable directivity (side lobe level) was obtained in the horizontal direction as shown in FIG. 15, and in the vertical direction as shown in FIG. 16.

### THIRD EMBODIMENT

FIG. 10 is a view explaining a configuration of triplate-type planar array antenna according to a third embodiment of the invention.

The third embodiment has a configuration in which arbitrary adjoining array antennas among a plurality of horizontal array antennas in the horizontal direction have a common slot opening 7 in the horizontal direction. In other words, the slot opening 7 extends over a plurality of the array antennas. If the number of radiating elements 5 in the horizontal direction of one array antenna is assumed to be, for example, two, and the slot opening 7 extends over two array antennas, the slot opening 7 is correspond to four radiating elements 5 in the horizontal direction.

It is also preferable in the third embodiment, as in the case of the second embodiment, that each array (center) spacing D1 for the plurality of slot openings 7, that is, the array spacings D1 in the vertical direction is configured at 0.85 through 0.93 times the free space wavelength λo for the center frequency of a frequency band in use. Moreover, it is preferable in the third embodiment, as in the case of the second embodiment, that the array spacings D2 for the plurality of radiating elements 5 in the horizontal direction are also configured at 0.85 through 0.93 times the free space wavelength λo for the center frequency of the frequency band in use.

Here, experiments have been conducted under the following concrete conditions.

That is, three array antennas, as in the case of the second embodiment, were configured to be arranged in the horizontal direction. However, the difference from the configuration of the second embodiment is that the one slot opening 7 is configured not to be corresponding to one array antenna in the horizontal direction, but to be provided in such a way that the slot opening 7 extends over the left two array antennas. In other words, two slot openings 7, which are different from each other in the length in the longitudinal direction, are provided in the horizontal direction. That is, four radiating elements 5 are corresponding to the longer slot opening 7, and two radiating elements 5 are corresponding to the shorter slot opening 7. As in the case of the second embodiment, 16 slot openings 7 are provided in the vertical direction. As in the case of the second embodiment, the number of the radiating elements 5 of each array antenna was 32, and the whole number of radiating elements 5 was 96.

Experiment data was obtained under the above-described conditions as shown in FIGS. 17 through 19.

FIG. 17 is a view showing the gain of each of 32 radiating elements in the triplate-type planar array antenna with the above-described concrete configuration. FIG. 18 is a view showing the directivity (side lobe level) of a plane (horizontal plane) formed by the two radiating elements, which are arranged in the horizontal direction, in the triplate-type planar array antenna with the above-described concrete configuration. FIG. 19 is a view showing the directivity (side lobe level) of a plane (vertical plane) formed by 16 radiating elements, which are arranged in the vertical direction, in the triplate-type planar array antenna with the above-described concrete configuration.

As shown in FIG. 17, each radiating element had a gain of 18 dBi or more, and the stable directivity (side lobe level) was obtained in the horizontal direction as shown in FIG. 18, and in the vertical direction as shown in FIG. 19 in much the same manner as that of the second embodiment.

Moreover, though a slot opening 7 has been configured to extend over the plurality of array antennas, a plurality of slot openings 7 may be provided in the horizontal direction in one array antenna. In other words, there may be a configuration in which a plurality of radiating elements 5 in the horizontal direction in one array antenna are divided into some groups, and one slot opening 7 is corresponding to each group.

Considering the above configuration and the third embodiment together, it may be generally said that an arbitrary number of slot openings 7 can be provided in the horizontal direction of the antenna circuit board 3 regardless of the number of the array antennas.

Moreover, the basic shapes of the radiating element 5 and the slot 7 may be square or circle, though they have been assumed to be rhombic in the above explanation.

Industrial Applicability

According to the present invention, there can be realized the triplate-type planar array antenna in which there is a high degree of flexibility in setting beam widths on a desired radiating plane, and a lower side lobe level can be secured even in a wider-angle direction without deteriorating the characteristics of a high-gain and high-efficiency triplate-type planar array antenna according to the prior art.

1. A triplate-type planar array antenna comprising:
an antenna circuit board on which an antenna circuit including a plurality of radiating elements, which are vertically and horizontally arrayed in a two-dimensional manner, and feedlines is formed;
two pieces of dielectric substances between which said antenna circuit board is sandwiched at the both sides;
a ground conductors laminated on one dielectric substance; and
a slot board laminated on the other dielectric substances, wherein
said slot board has a plurality of slot openings, each corresponding to said plurality of radiating elements with a linear arrangement.

2. The triplate-type planar array antenna according to claim 1, wherein said plurality of slot openings are formed on said slot board in series in the longitudinal direction of said slot openings.

3. The triplate-type planar array antenna according to claim 2, wherein a plurality of antenna circuits are formed on said antenna circuit board, said plurality of slot openings are formed on said slot board in series in the longitudinal direction of said slot openings, and the number of said plurality of slot openings corresponds to the number of said plurality of antenna circuits.

4. The triplate-type planar array antenna according to claim 1, wherein a plurality of antenna circuits are formed on said antenna circuit board, and at least one slot opening extending over at least two of said antenna circuits is formed on said slot board in series in the longitudinal direction of said slot openings.

5. The triplate-type planar array antenna according to claim 1, wherein each array spacing for said plurality of slot openings in a direction perpendicular to the longitudinal direction of said plurality of slot openings is set at 0.85 through 0.93 times a free space wavelength corresponding to a center frequency of a frequency band in use.

6. The triplate-type planar array antenna according to claim 1, wherein each array spacing for said plurality of radiating elements in the longitudinal direction of said plurality of slot openings is set at 0.85 through 0.93 times a free space wavelength corresponding to a center frequency of a frequency band in use.

7. The triplate-type planar array antenna according to claim 4, wherein each array spacing for said plurality of slot openings in a direction perpendicular to the longitudinal direction of said plurality of slot openings is set at 0.85 through 0.93 times a free space wavelength corresponding to a center frequency of a frequency band in use.

8. The triplate-type planar array antenna according to claim 7, wherein each array spacing for said plurality of radiating elements in the longitudinal direction of said plurality of slot openings is set at 0.85 through 0.93 times a free space wavelength corresponding to a center frequency of a frequency band in use.
